(19) United States
(12) Patent Application Publication
(10) Pub. No.: US 2024/0354760 A1
(43) Pub. Date: Oct. 24, 2024

(54) SYSTEMS AND METHODS FOR MANAGING VIRTUAL VEHICLES ASSOCIATED WITH CORRESPONDING PHYSICAL VEHICLES

(71) Applicant: Toyota Connected North America, Inc., Plano, TX (US)

(72) Inventors: David Tsai, Irvine, CA (US); Will Hargis, Celina, TX (US)

(73) Assignee: Toyota Connected North America, Inc., Plano, TX (US)

(21) Appl. No.: 18/303,903

(22) Filed: Apr. 20, 2023

(51) Int. Cl. G06Q 20/40; G06Q 20/38

(52) U.S. Cl. CPC G06Q 20/401; G06Q 20/389

(57) ABSTRACT

In one embodiment, a system for managing a virtual vehicle includes one or more processors, and a non-transitory computer-readable medium storing instructions that cause the one or more processors to receive a vehicle identification number of a physical vehicle, and generate a non-fungible token for the physical vehicle on a blockchain. The non-fungible token provides a virtual vehicle corresponding to the physical vehicle. The virtual vehicle is renderable in a virtual environment. The instructions further cause the processors to monitor one or more vehicle registration systems for a change in a title of the physical vehicle using the vehicle identification number, and when a change in the title of the physical vehicle is determined, determine a new owner of the physical vehicle and record a new owner name of the new owner of the physical vehicle on the blockchain to transfer ownership of the virtual vehicle to the new owner.

### TECHNICAL FIELD

The present specification relates to non-fungible tokens and, more particularly, to systems and methods for managing virtual vehicles enabled by non-fungible tokens that are tied to corresponding physical vehicles.

### BACKGROUND

Virtual worlds are computerized environments where users can interact with each other and objects using avatars. Virtual objects are available in virtual worlds to use. For example, a user may wear virtual clothing and virtual shoes. The virtual objects may look like and operate similarly to their real-world counterparts. However, the virtual objects may not operate in the virtual worlds in a manner that is similar to the operation of corresponding physical objects in the physical world. Additionally, virtual objects may be generated on a one-to-one basis with respect to real-world physical objects. It may be desirable to ensure that the owner of the physical object is also the owner of the virtual object, and that ownership between the physical object and the virtual object is not split. However, it is different to ensure ownership of both the physical and virtual object is the same.

Accordingly, systems and methods for managing virtual objects may be desired.

### SUMMARY

In one embodiment, a system for managing a virtual vehicle includes one or more processors, and a non-transitory computer-readable medium storing instructions that cause the one or more processors to receive a vehicle identification number of a physical vehicle, and generate a non-fungible token for the physical vehicle on a blockchain. The non-fungible token provides a virtual vehicle corresponding to the physical vehicle. The virtual vehicle is renderable in a virtual environment. The instructions further cause the one or more processors to monitor one or more vehicle registration systems for a change in a title of the physical vehicle using the vehicle identification number, and when a change in the title of the physical vehicle is determined, determine a new owner of the physical vehicle and record a new owner name of the new owner of the physical vehicle on the blockchain to transfer ownership of the virtual vehicle to the new owner of the physical vehicle.

In another embodiment, a system for managing a virtual vehicle includes one or more processors, and a non-transitory computer-readable medium storing instructions that cause the one or more processors to receive a vehicle identification number of a physical vehicle that is subject to a lease, and generate a non-fungible token for the physical vehicle on a blockchain. The non-fungible token provides a virtual vehicle corresponding to the physical vehicle. The virtual vehicle is renderable in a virtual environment. The instructions further cause the one or more processors to record ownership of the non-fungible token to a lessee of the physical vehicle at a start of the lease on the blockchain, wherein ownership of the non-fungible token grants access to the virtual vehicle, and upon termination of the lease, automatically records ownership of the non-fungible token to the lessor on the blockchain, thereby terminating access to the virtual vehicle for the lessee.

In yet another embodiment, a system for managing a virtual vehicle includes one or more processors, and a non-transitory computer-readable medium storing instructions that cause the one or more processors to generate a non-fungible token for a physical vehicle on a blockchain, the non-fungible token providing a virtual vehicle corresponding to the physical vehicle, wherein the virtual vehicle is renderable in a virtual environment, receive a request to provide temporary access of the physical vehicle and the virtual vehicle to a third party for a duration of time, and record the third party on the blockchain to transfer ownership of the virtual vehicle to the third party for the duration of time.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 illustrates a physical vehicle and a non-fungible token according to one or more embodiments described and illustrated herein;

FIG. 2 illustrates a user viewing a virtual vehicle in a virtual environment using a virtual reality headset according to one or more embodiments described and illustrated herein;

FIG. 3 illustrates a virtual vehicle operating in a virtual environment according to one or more embodiments described and illustrated herein;

FIG. 4 illustrates a system for managing non-fungible tokens representing virtual vehicles according to one or more embodiments described and illustrated herein;

FIG. 5A illustrates transfer of ownership from a first owner of a physical vehicle to a second owner of the physical vehicle according to one or more embodiments described and illustrated herein;

FIG. 5B illustrates transfer of a physical vehicle from an owner to a renter of the physical vehicle according to one or more embodiments described and illustrated herein;

FIG. 6 illustrates a flowchart of an example method for managing a non-fungible token representing a virtual vehicle according to one or more embodiments described and illustrated herein;

FIG. 7 illustrates an example head unit of a physical vehicle for authenticating a third party for temporary ownership of a virtual vehicle associated with the physical vehicle according to one or more embodiments described and illustrated herein;

FIG. 8 illustrates an example physical vehicle with a plurality of sensors according to one or more embodiments described and illustrated herein;

FIG. 9 illustrates a physical vehicle and a plurality of virtual vehicles rendered in a plurality of virtual worlds according to one or more embodiments described and illustrated herein;

FIG. 10 illustrates a method for rendering and operating a virtual vehicle in a virtual world according to one or more embodiments described and illustrated herein; and

FIG. 11 illustrates an example computing system for generating, managing, rendering and operating a virtual vehicle in a virtual environment according to one or more embodiments described and illustrated herein.

### DETAILED DESCRIPTION

The embodiments disclosed herein are directed to systems and methods for generating and managing non-fungible tokens representing virtual vehicles that correspond to physical vehicles. Ownership in the non-fungible token representing virtual vehicle is tied to ownership of the physical vehicle. When a change in title of the physical vehicle occurs in the physical world, this change is represented on a blockchain by recording the new owner of the non-fungible token and therefore the virtual vehicle that is tied to the physical vehicle.

The embodiments disclosed herein also describe systems and methods for generating vehicle profiles corresponding to the performance of individual physical vehicles, and also rendering and operating virtual vehicles in virtual environments based on the vehicle profiles.

The “metaverse” is made up of one or more virtual worlds operating on computer networks. Non-limiting examples of virtual worlds include Second Life™ operated by Linden Research Inc. of San Francisco, CA, Minecraft® operated by Microsoft, Inc. of Redmond, WA, Roblox® operated by the Roblox Corporation of San Mateo, CA, Fortnite® operated by Epic Games of Cary, NC. The Sims® operated by Electronic Arts of Redwood City, CA, and The Sandbox operated by Pixowl of Hong Kong. Users may experience the metaverse using one or more avatars that represent them. Avatars may interact with one another in the virtual worlds.

Virtual objects may also be created, used and exchanged within the virtual worlds. For example, a user may purchase virtual articles of clothing, such as jeans and shoes. The jeans and shoes have certain attributes, such as size, color, shape, texture. In some cases, the virtual objects may correspond to actual physical objects. For example, a shoe company may make a certain model of a physical shoe, and also sell a virtual shoe having similar characteristics to the physical shoe. As a further example, a user may receive a virtual shoe in the form of a non-fungible token when purchasing the physical shoe. The non-fungible token may be used to unlock the virtual shoe in one or more virtual worlds so that the user's avatar may “wear” the shoe.

Virtual worlds may be very large. For example a virtual world may be defined by thousands of “lands.” Without teleportation, it may be difficult to travel long distances within the virtual world. Virtual objects in the form of transportation vehicles, such as cars, trucks, busses, planes, boats, and the like may be available for ownership and/or rental for mobility within the virtual worlds. For example, a user's avatar may purchase a ticket on a virtual plane to fly from one location to another. As another example, a user may use a virtual car to go on a road trip from one location to another.

As stated above, a user may purchase a physical vehicle in the physical world, and receive a digital representation of the vehicle in the form of a virtual vehicle. The virtual vehicle may look similar to the physical vehicle that the user owns in the physical world. The virtual vehicle may be provided in a form of a non-fungible token that is stored on a blockchain, for example. The non-fungible token ensures that the virtual vehicle is authentic, and that it cannot be replicated.

Virtual worlds have an area defined by distances and elevations. Thus, a virtual vehicle can travel across a virtual landscape at a virtual speed. For example, a virtual vehicle may travel across a virtual landscape at an average speed of 100 kmh as a physical vehicle would travel across a physical landscape. A virtual vehicle traveling at an average speed of 100 kmh will travel 100 km in one hour. It is noted that distances in the virtual world may not have a one-to-one relationship to distances in the physical world. For example, 1 km in the physical world may be 0.5 km in a virtual world.

Embodiments of the present disclosure provide for vehicle profiles that store vehicle performance attributes that are derived from actual sensor data of vehicles. The vehicle profiles may be used to render and operate virtual vehicles that perform within virtual worlds in a manner similar to their corresponding physical vehicle counterparts. Thus, a physical vehicle owner may also have a virtual vehicle that has the same maximum speed, maximum acceleration, braking distance, handling, steering, and energy efficiency as the corresponding physical vehicle.

Various embodiments of systems and methods for generating and maintaining non-fungible tokens representing virtual vehicles, as well as systems and methods for vehicle profiles storing vehicle performance attributes, and rendering and operating virtual vehicles in virtual worlds according to vehicle profiles, are described in detail below.

When a physical vehicle is manufactured, a non-fungible token associated with that physical vehicle is generated and recorded on a blockchain, such as the Ethereum blockchain, for example. The non-fungible token may be associated with the physical vehicle by its vehicle identification number (VIN). A VIN is a unique alpha-numeric code that is tied to an individual physical vehicle.

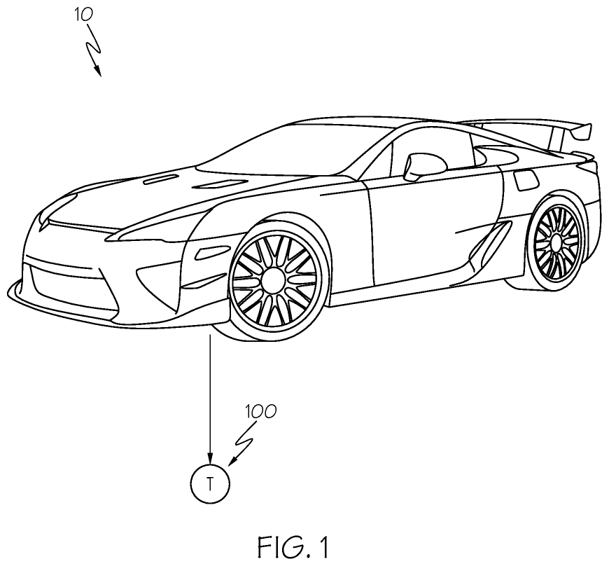

Referring to FIG. 1, a physical vehicle 10 is manufactured and a non-fungible token 100 is generated that is associated with the VIN of the physical vehicle. In some embodiments, the non-fungible token 100 is generated upon generation of the VIN before or during manufacturing of the physical vehicle 10. In other embodiments, the non-fungible token 100 may be generated by a vehicle owner long after the manufacture of the physical vehicle 10.

The owner of the non-fungible token 100, which is the owner of the physical vehicle 10, is also recorded on the blockchain. In the example of where the non-fungible token is generated upon generation of the VIN, the owner of the non-fungible token 100 may be recorded as the vehicle manufacturer, or an intended dealer that the physical vehicle 10 will be delivered to. The non-fungible token 100 is always tied to the physical vehicle 10, meaning that the owner of the physical vehicle 10 has access to the non-fungible token 100.

The non-fungible token 100 provides access to a virtual vehicle that is a virtual representation of the physical vehicle 10 to which it is associated. For example, the non-fungible token 100 may point to software code that provides instructions to render a virtual vehicle in a virtual environment.

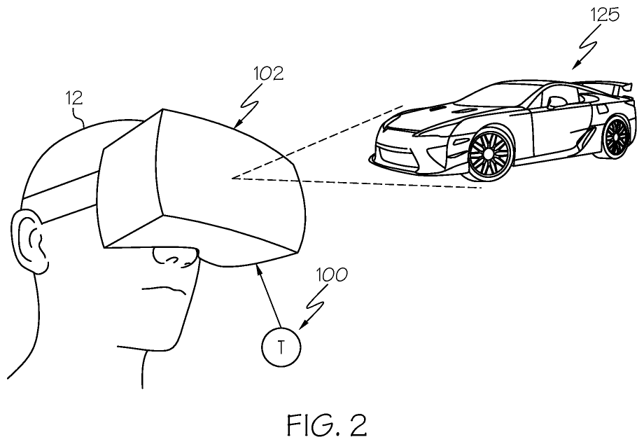

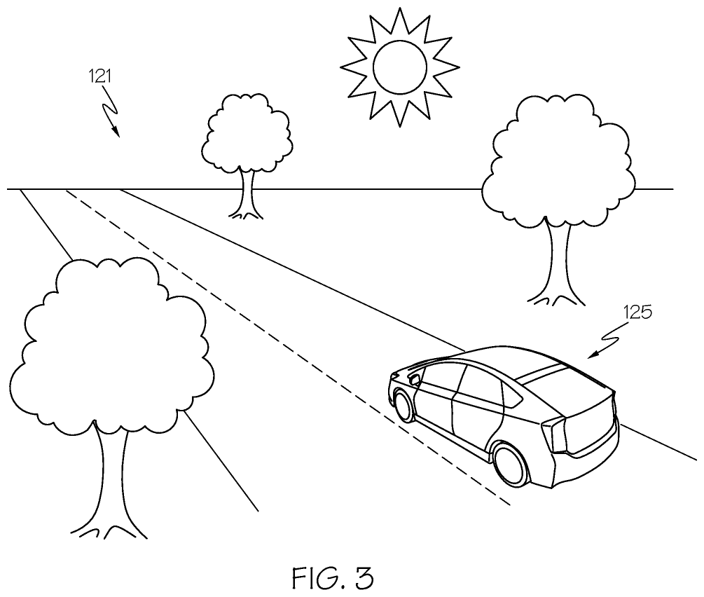

FIG. 2 illustrates a user 12, which may be an owner of the physical vehicle 10 of FIG. 1, where a virtual reality headset 102 is used to render a virtual environment. It should be understood that other display devices may be used, such as augmented reality glasses, smartphones, tablet devices, and the like. The virtual reality headset 102 is used to view and operate a virtual vehicle 125 corresponding to the physical vehicle 10 by way of the non-fungible token. As a non-limiting example, the non-fungible token 100 may be stored in a digital wallet where the user 12 can access a plurality of non-fungible tokens. Selection of the non-fungible token 100 associated with the physical vehicle 10 causes the virtual vehicle 125 to be rendered in a virtual environment. FIG. 3 illustrates a virtual vehicle 125 traveling within a virtual environment 121. The virtual reality headset 102 renders the virtual vehicle 125 from any perspective, such as when the user approaches the virtual vehicle 125, when the user is sitting in the cockpit and driving the virtual vehicle 125, or from different views of the virtual vehicle 125 while the user drives the virtual vehicle 125. As described in more detail below, the virtual vehicle 125 shares physical and performance attributes with its corresponding physical vehicle 10.

As stated above, ownership of the non-fungible token 100 follows ownership of the physical vehicle 10. In embodiments of the present disclosure, the title of the physical vehicle 10 is used to determine ownership of the non-fungible token 100 and thus the virtual vehicle 125. The title of the physical vehicle 10 is typically recorded at a government registration system, such as a state recorder's office, bureau of motor vehicles, department of motor vehicles, and the like. These government registration systems may store the titles in a database, for example.

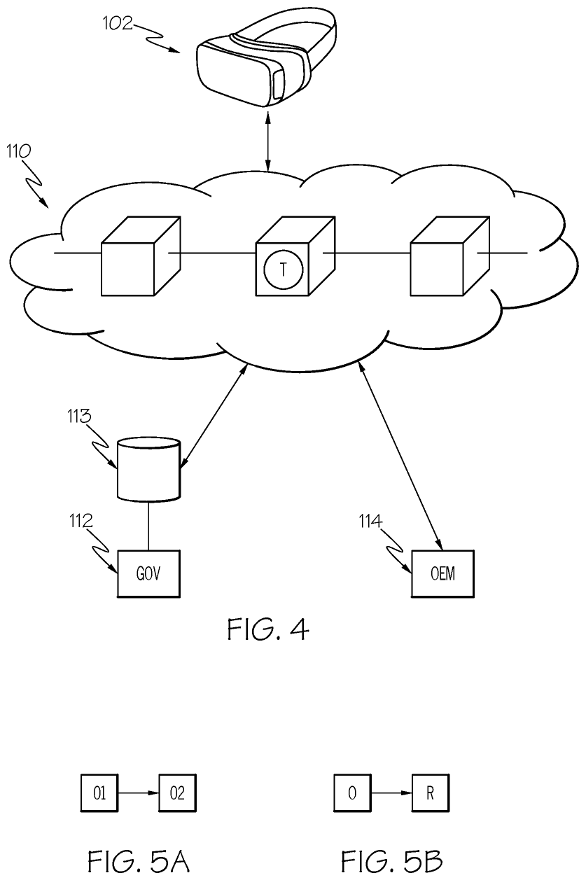

FIG. 4 illustrates a non-limiting example of a high level system for recording ownership of a non-fungible token 100 based on a title of a physical vehicle. In this example, a vehicle manufacturer 114 creates a non-fungible token 100 storing the VIN and original owner of a physical vehicle 10 upon manufacture of the physical vehicle 10. This non-fungible token and its information is recorded on a blockchain 110, such as the Ethereum blockchain, for example. The system then monitors one or more government registration systems 112, such as state departments of motor vehicles for changes of the title of the physical vehicle 10. This may be done by searching title records of databases 113 of the one or more government registration systems 112 for the VIN of the physical vehicle 10, and comparing an owner's name on the title with a previously noted owner's name. If there is a difference between the current name on the title with the previously noted owner's name, then a change in ownership of the physical vehicle 10 has occurred.

When a change in the title of the physical vehicle is determined, the new owner of the physical vehicle is determined from the title, and the name of the new owner of the physical vehicle 10 is recorded on the blockchain 110 to transfer ownership of the non-fungible token (and thus the virtual vehicle 125) to the new owner of the physical vehicle 10.

FIG. 5A illustrates how a physical vehicle and a virtual vehicle associated with a non-fungible token may be transferred from a first owner O1 to a second owner O2. FIG. 5B illustrates how a physical vehicle and a virtual vehicle associated with a non-fungible token may be transferred from an owner O to a renter R. The renter R may be a paid renter of the physical vehicle, or a person who is merely borrowing the physical vehicle from the owner and would like to gain access to the virtual vehicle while he or she borrows the physical vehicle.

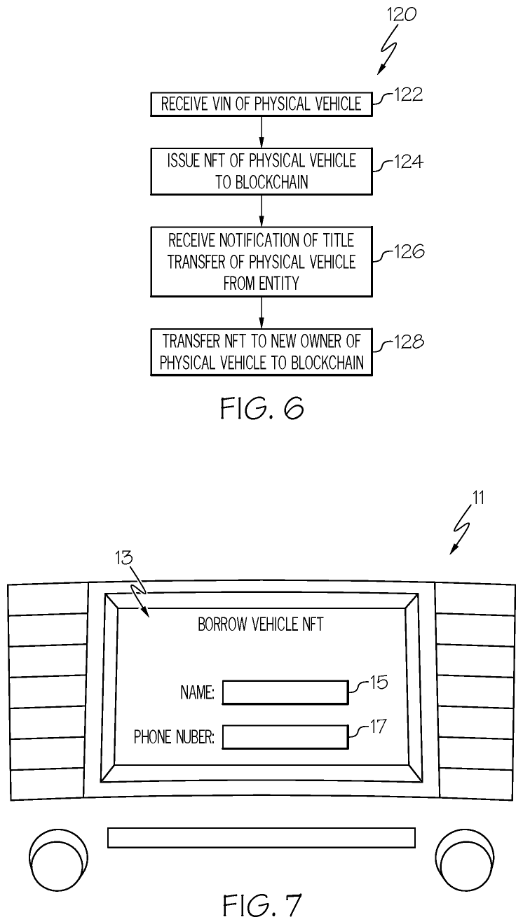

FIG. 6 illustrates an example method for managing a virtual vehicle as illustrated by flowchart 120. At block 122, a VIN of a physical vehicle is received. The vehicle may be a vehicle that is assigned for production, a vehicle that is currently in production or has just been manufactured. In these instances the VIN that is received by the system is from the automobile manufacturer. In other instances, the physical vehicle may have been registered for some time. For example, an owner of an existing physical vehicle may desire to create a non-fungible token and virtual vehicle of her physical vehicle because no such virtual vehicle had been yet created. In this instance, the VIN would be received from a vehicle owner.

At block 124, a non-fungible token of the physical vehicle is issued to a blockchain, such as the Ethereum blockchain, for example. The VIN and the current owner of the physical vehicle is recorded on the blockchain. The non-fungible token tokenizes the physical vehicle and thus digitally represent the physical vehicle in the form of a virtual vehicle that may be operated in a virtual environment of the metaverse. The non-fungible token may link to software code storing attributes of the virtual vehicle and how to render the virtual vehicle in a virtual environment.

At block 126, the system receives notification of a title transfer of the physical vehicle from an entity, such as a governmental registration system. The system may actively search one or more governmental registration systems to identify changes in the title of the physical vehicle. As another example, a new owner of the physical vehicle may submit a request for transfer of ownership of the virtual vehicle to him or her. The system may verify that the transfer is proper by looking of the record of the title of the physical vehicle at the appropriate governmental registration system.

When the new owner of the physical vehicle is verified, the transfer of the non-fungible token and thus the virtual vehicle is recorded on the appropriate blockchain at block 128. The new owner of the physical vehicle may then access and utilize the virtual vehicle by applying his or her credentials.

Embodiments may also be utilized when the “owner” of the physical vehicle is a lessee of the vehicle. In such instances, the lessor of the physical vehicle may provide the lessee with temporary ownership of the virtual vehicle according to terms of the lease by recording the same on the blockchain. The non-fungible token may store a lease completion date to automatically transfer the non-fungible token to the lessor in some embodiments. Upon termination of the lease, ownership of the non-fungible token back to the lessor may be automatically recorded, thereby terminating access of the virtual vehicle for the lesscc.

As stated above, in some cases an owner of a physical vehicle may desire to lend, rent or otherwise provide access of the physical vehicle and the virtual vehicle to a third party. The system may receive a request to provide temporary access of the physical vehicle and the virtual vehicle to a third party for a duration of time. The third party may be recorded as a temporary owner of the virtual vehicle on the blockchain. In some embodiments, the third party is verified as being both in possession of the physical vehicle and properly entitled to the virtual vehicle before access to the virtual vehicle is provided. As a non-limiting example, authentication may be provided using a display of the vehicle, which ensures a high-level of confidence that the third party is entitled to the virtual vehicle.

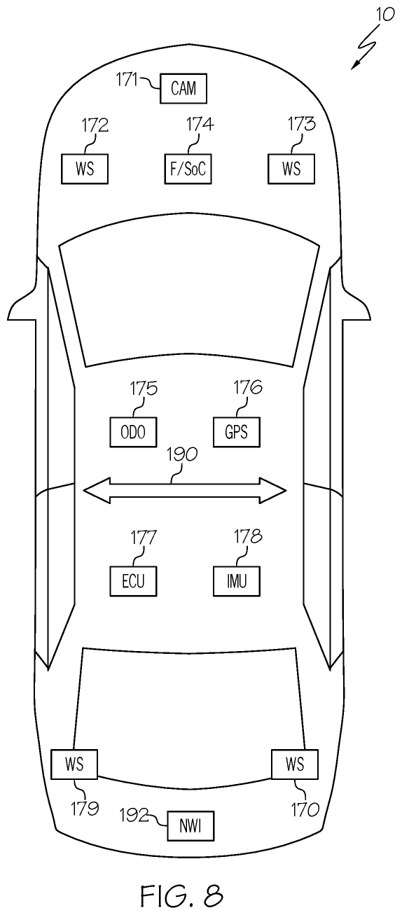

FIG. 7 illustrates an example vehicle head unit 11 having a display that displays a graphical user interface 13 whereby a third party who has gained temporary access to the physical vehicle may authenticate herself as a person properly having access to the virtual vehicle. It should be understood that the graphical user interface 13 is provided for illustrative purposes only. At a basic level, the graphical user interface 13 may ask for the third party's name 15 and identifiable information, such as a phone number 17. The owner of the physical vehicle may have provided this information about the third party in a manner that is encrypted on the blockchain, or a smart contract stored off the blockchain. Information provided by the third party in the graphical user interface 13 is compared against what is stored in the blockchain (or smart contract) and, if it matchings an authentication is verified, the third party is recorded as being a temporary owner of the virtual vehicle for a duration of time. The duration of time may be recorded in the non-fungible token or a smart contract, for example. As another example, the owner of the physical vehicle and the third party may have agreed upon a passcode that must be provided in the graphical user interface 13 to gain access to the virtual vehicle.

As noted hereinabove, the virtual vehicle may have performance characteristics in a virtual environment that are similar to the performance characteristics in the physical world. For example, when the gas or battery level is low in the physical vehicle, the virtual vehicle will also have a low gas or battery level. Acceleration, top speed, and handling characteristics are shared between the physical vehicle and the virtual vehicle. Data from vehicle sensors on the physical vehicle are utilized to ensure that the performance characteristics are shared.

Referring now to FIG. 8, an example physical vehicle 10 and its example sensors and electronics is schematically illustrated. It should be understood that embodiments are not limited to any particular vehicle and any particular sensors. The physical vehicles described herein are not limited to cars, and may include trucks, busses, four-wheelers, two-wheelers, three-wheelers, planes, motorized equipment, boats, and the like.

The illustrated example physical vehicle 10 is a car of a particular make, model, trim level, and year. The physical vehicle 10 has one or more electronic control units 177 (e.g., processors) that are communicatively coupled (e.g., by a wired or wireless connection) to a vehicle communications bus 190 (e.g., a control area network (CAN) bus). A plurality of vehicle sensors are also communicatively coupled to the communications bus 190, and provide vehicle sensor data to the one or more electronic control units 177. Any number and type of vehicle sensors may be included in the physical vehicle 10. The example physical vehicle 10 of FIG. 1 includes four wheel sensors 170, 172, 173, and 179, one or more camera sensors 171, an energy sensor 174 providing data regarding remaining propulsion energy (e.g., a fuel gauge or a state of charge sensor that monitors the state of charge of a battery pack of an electric vehicle), an odometer 175, one or more global positioning sensors 176, one or more initial measurement units 178, and network interface hardware 192. It should be understood that more or fewer sensors may be used depending on the type of physical vehicle.

The various vehicle sensors produce vehicle data that are provided to the communications bus 190 and may be received by the one or more electronic control units 177. The electronic control units 177 and/or one or more processors of a remote computing device (not shown) may calculate vehicle performance attributes. Vehicle performance attributes are not limited by this disclosure. Non-limiting example vehicle performance attributes include fuel economy (e.g., MPG) or efficiency (e.g., MPGe) (collectively referred to herein as “energy efficiency”), maximum speed, acceleration (e.g., 0 mph to 60 mph), handling, braking distance, off-road capabilities, torque, horse power, suspension, roll center, weight distribution, rolling resistance, coefficient of friction, and/or the like. These performance attributes may be derived from the many sensors of the physical vehicle 10. As described in more detail below, the vehicle sensor data outputted by the various sensors are used to derive the vehicle performance attributes that are stored in a vehicle profile that is further used to render and operate a corresponding virtual vehicle in virtual worlds.

The one or more camera sensors 171 provides data regarding the surrounding environment of the physical vehicle 10, such as precipitation, light conditions, or any other environmental conditions. The environmental conditions may be used to produce vehicle performance attributes in different environmental conditions. For example, a first set of vehicle performance attributes (e.g., acceleration, speed, etc.) may be derived for elevated temperature during sunny conditions, a second set of vehicle performance attributes may be derived for rainy conditions, and a third set of vehicle performance attributes may be derived for snowy conditions. Visual data provided by the cameras may be used to determine the environmental conditions. Other sensors may also be used to determine environmental conditions, such as a vehicle temperature sensor. It is noted that external data may also be used to determine environmental conditions, such as third party weather data.

The wheel sensors 172 may be any type of wheel sensor, such as, without limitation, wheel speed sensors used to determine the speed of the vehicle and/or determine wheel speed for anti-lock brake systems, automatic transmission control systems, vehicle dynamic control systems, and the like. The vehicle data produced by the wheel sensors 172 may be used to derive handling attributes, such as how the physical vehicle 10 performs in various weather conditions, such as rainy or icy conditions. The wheel sensors 172 may be used as a speedometer of the vehicle, or a separate speedometer sensor may be used in some embodiments.

An energy sensor 174 provides information regarding how much propulsion energy remains. For an internal combustion engine or a fuel cell, the energy sensor 174 may be a fuel gauge that provides data regarding how much fuel is remaining. For a battery electric vehicle, the energy sensor 174 may be a state of charge sensor that provides data regarding a charge level of the battery pack.

The odometer sensor 175 provides information regarding the distance that the physical vehicle 10 travels. Data from the odometer sensor 175 and the energy sensor may be used to derive the efficiency of the physical vehicle. In some embodiments, the one or more electronic control units 177 calculates the efficiency. In other embodiments, a remote computing device uses vehicle data of the odometer sensor 175 and the energy sensor 174 to calculate the efficiency of the physical vehicle.

The global positioning sensor 176 provides location data regarding the location of the physical vehicle 10. The location data can be used to obtain other information, such as elevation. Energy efficiency of the physical vehicle 10 depends on the change in elevation of the road. A vehicle is highly efficient when travelling downhill and less efficient when traveling uphill. The energy efficiency of the physical vehicle 10 may be calculated for different road grades based on the locations traveled by the physical vehicle 10. This information may then be stored as one or more vehicle performance attributes in a vehicle profile.

One or more inertial measurement units 178 may also be provided on the physical vehicle 10. Non-limiting examples of inertial measurement units 178 include accelerometers and gyroscopes. The vehicle data from the one or more inertial measurement units 178, (alone or in combination with vehicle data from other sensors) can be used to derive vehicle performance attributes, such as vehicle handling attributes. Vehicle data from the inertial measurement units 178 can be used to characterize how the physical vehicle 10 handles corners at various speeds, how it moves when accelerating or decelerating, and the like.

Network interface hardware 192 may also be provided to communicate data with remote computing devices. For example, vehicle sensor data and/or vehicle-calculated vehicle performance attributes may be communicated with one or more remote computing devices that create a vehicle profile of the physical vehicle 10 that is used to render and operate a virtual vehicle that represents the physical vehicle 10.

As stated above, the vehicle sensor data of the physical vehicle 10 are used to derive vehicle performance attributes that describe the performance of the physical vehicle 10 under various conditions. Thus, the vehicle performance attributes are used to model the movement of the physical vehicle 10. These vehicle performance attributes are stored in a digital vehicle profile that is used by virtual world computing systems to render and operate a virtual vehicle having vehicle performance attributes in one or more virtual worlds that are similar to the vehicle performance attributes of the physical vehicle 10 in the physical world.

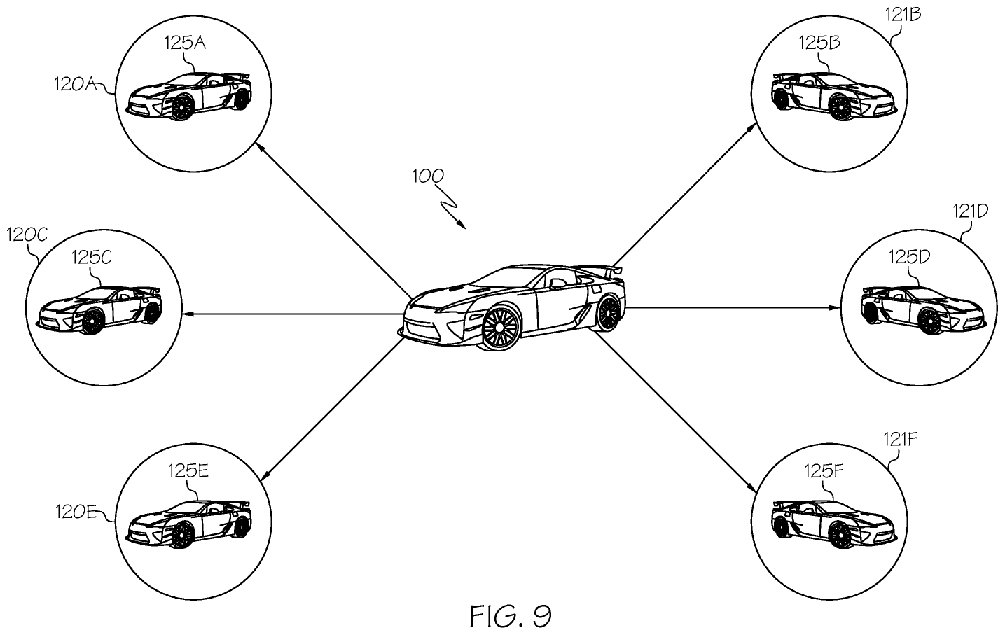

FIG. 9 illustrates a physical vehicle 10 and a plurality of corresponding virtual vehicles 125A-125F rendered and operated in a plurality of virtual worlds 120A-120F. The virtual worlds 120A-120F may be operated by different operating entities. In other examples, a single operating entity may operate more than one virtual world. As a non-limiting example, virtual world 121A and virtual world 121B may be operated as Minecraft worlds operated by Microsoft Corp., virtual world 121C may be a Fortnite virtual world operated by Epic Games, virtual world 121D may be Second Life worlds operated by Linden Research Inc., virtual world 121E, and virtual world 172F may be Sims virtual worlds operated by Electronic Arts. In each case, the computing device(s) responsible for providing the virtual world receives the vehicle profile associated with the physical vehicle 10 and renders a virtual vehicle 125 in the virtual world 121.

The vehicle profile includes information associated with the physical vehicle 10, such as make, model, year, trim-level, color, and/or the like. The vehicle profile also includes the vehicle performance attributes of the physical vehicle 10. The computing device(s) of the virtual world accesses the vehicle profile and renders the virtual vehicle in accordance with the design aesthetic of the particular virtual world. Different virtual worlds have different design aesthetics. As a non-limiting example, the virtual vehicle may be rendered in a blocky manner in a Minecraft virtual world whereas the virtual vehicle may be rendered in a realistic manner in a Second Life virtual world. The vehicle profiles of the embodiments of the present disclosure enable virtual vehicles to be rendered and operated in any virtual world platform. The computing device(s) of the virtual world read the information from the vehicle profile and interpret it to render the vehicle in accordance with its own standards.

In some embodiments, the vehicle profile is tokenized and stored on a blockchain network as a non-fungible token. As a non-limiting example, a non-fungible token storing the vehicle profile may be minted on the Ethereum blockchain. Tokenizing ensures authenticity of the vehicle profile and maintains a one-to-one relationship between the physical vehicle 10 and the virtual vehicle 125. A user may rent, sell, loan or otherwise transfer the virtual vehicle 125 by transferring or providing access to the non-fungible token of the vehicle profile.

The virtual vehicle 125 is rendered and operated in a manner according to the information stored within the vehicle profile. Thus, the performance of the virtual vehicle 125 in the virtual world 121 corresponds to the performance of the physical vehicle 10 in the physical world. For example, if the physical vehicle 10 has an average highway economy of 15 km/liter, then the corresponding virtual vehicle 125 will have an average highway economy of 15 km/liter in the virtual world 121. As another example, the virtual vehicle 125 will handle corners in the virtual world 121 in a manner similar to the corresponding physical vehicle 10 in the physical world. The owner may drive the virtual vehicle 125 in different virtual worlds 121 in a manner similar to the physical vehicle 10 in the physical world. The virtual vehicle 125 cannot exceed the performance of the corresponding physical world. For example, if the maximum speed of the physical vehicle is 200 kph, then the maximum speed of the virtual vehicle 125 in the virtual world 121 is 200 kph.

Modifications made by the owner of the physical vehicle 10 will be recorded by the vehicle sensors, and the vehicle performance attributes within the vehicle profile will be updated. As a non-limiting example, a user may upgrade the physical vehicle 10 with a turbo-boost system. Vehicle sensor data will reflect the change in acceleration performance of the physical vehicle 10 and the vehicle performance attribute(s) of the vehicle profile will be updated. The virtual vehicle 125 will then exhibit a corresponding change in acceleration performance.

In some embodiments, a calibration routine may be used to generate vehicle sensor data to create and/or update the various vehicle performance attributes. A graphical user interface may provide instructions to the owner of the physical vehicle to perform certain maneuvers to generate vehicle sensor data needed to create and/or update vehicle performance attributes. As a non-limiting example, a vehicle head unit may present the graphical user interface. As another non-limiting example, a mobile phone may display the graphical user interface. The instructions may include statements such as “Accelerate from a stop position to sixty miles per hour with the maximum accelerator pedal pressure” or “Handle the curve on Smith Road at 15 kph.” In some embodiments, the calibration period may be a duration of time. In other embodiments, the vehicle profile is continuously updated as the owner drives the physical vehicle.

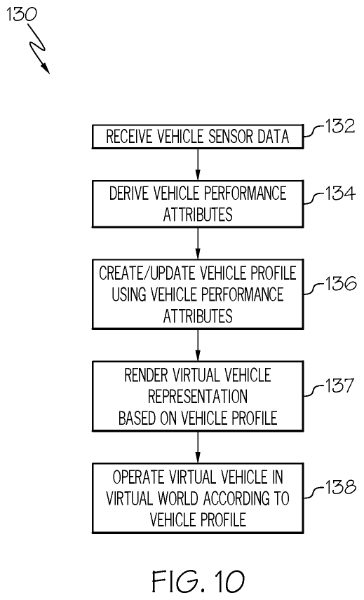

FIG. 10 is a flowchart 130 illustrating a method of generating, rendering and operating a virtual vehicle that corresponds with a physical vehicle. The steps of the flowchart 130 may be performed by one or more of a vehicle computing system and a dedicated computing system responsible for generating the virtual world.

At block 132 vehicle sensor data is received. The vehicle sensor data is generated by any number of sensors on a physical vehicle. The vehicle sensor data is representative of the driving performance of the physical vehicle. Other data may also be received at block 132, such as weather data, map data, and any other relevant data.

At block 134, vehicle performance attributes are derived from the sensor data received at block 132. Vehicle performance attributes may be derived by the vehicle itself or a remote computing device. Vehicle performance attributes include efficiency, acceleration, maximum speed, and the like.

At block 136, a vehicle profile for the physical vehicle is created or updated with the vehicle performance attributes, depending on whether there yet exists a vehicle profile. The vehicle profile may also include other information regarding the physical vehicle, such as make, model, year, trim level, color, and/or the like. In some embodiments, the vehicle profile and its data is tokenized and minted on a blockchain as a non-fungible token. This non-fungible token may be used in different virtual worlds.

At block 137, a computing device responsible for rendering a virtual world reads the vehicle profile and generates a virtual vehicle accordingly. The virtual vehicle is displayed according to the make, model, year, trim, color, etc. stored in the vehicle profile.

At block 138, the computing device responsible for rendering the virtual world enables operation of the virtual vehicle in accordance with the vehicle performance attributes stored within the vehicle profile. Thus, the virtual vehicle performs similarly in a virtual world as the physical vehicle does in the physical world under similar conditions.

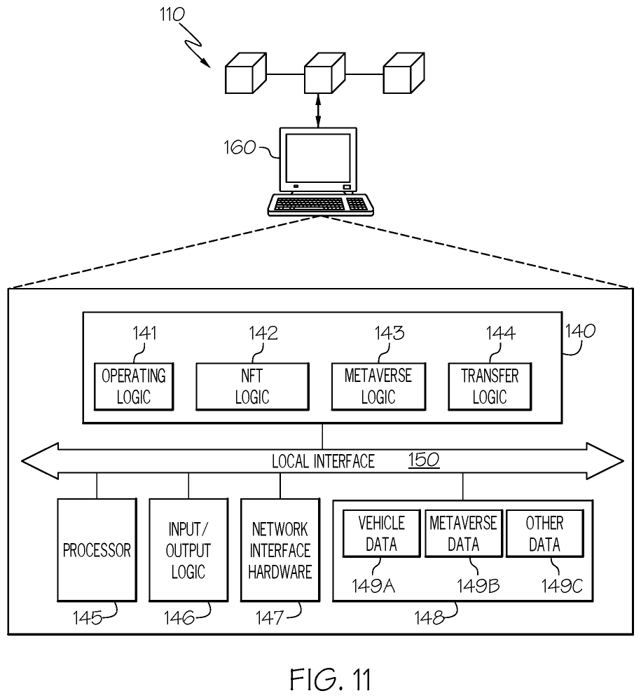

Embodiments of the present disclosure may be implemented by a computing device, and may be embodied as computer-readable instructions stored on a non-transitory memory device. Referring now to FIG. 11, an example system for managing virtual vehicles as a computing device 160 is schematically illustrated. The example computing device 160 provides a system for managing virtual vehicles, and/or a non-transitory computer usable medium having computer readable program code for managing virtual vehicles embodied as hardware, software, and/or firmware, according to embodiments shown and described herein. While in some embodiments, the computing device 160 may be configured as a general purpose computer with the requisite hardware, software, and/or firmware, in some embodiments, the computing device 160 may be configured as a special purpose computer designed specifically for performing the functionality described herein. It should be understood that the software, hardware, and/or firmware components depicted in FIG. 11 may also be provided in other computing devices external to the computing device 160 (e.g., data storage devices, remote server computing devices, and the like).

As also illustrated in FIG. 11, the computing device 160 (or other additional computing devices) may include a processor 145, input/output hardware 146, network interface hardware 147, a data storage component 148 (which may include vehicle data 149A (e.g., data regarding specifics of the physical vehicle, such as physical characteristics (color, model, etc.) and performance characteristics (handling, acceleration, etc.)), metaverse data 149B (e.g., data relating to the virtual environment in which the virtual vehicle operates), and any other data 149C for performing the functionalities described herein), and a non-transitory memory component 140. The memory component 140 may be configured as volatile and/or nonvolatile computer readable medium and, as such, may include random access memory (including SRAM, DRAM, and/or other types of random access memory), flash memory, registers, compact discs (CD), digital versatile discs (DVD), and/or other types of storage components.

Additionally, the memory component 140 may be configured to store operating logic 141, non-fungible token logic 142 for creating a virtual vehicle on the blockchain, metaverse logic 143 for generating the virtual vehicle and virtual environment, and transfer logic 144 for determining a change in physical vehicle title/ownership, as described herein (each of which may be embodied as computer readable program code, firmware, or hardware, as an example). It should be understood that the data storage component 148 may reside local to and/or remote from the computing device 160, and may be configured to store one or more pieces of data for access by the computing device 160 and/or other components.

A local interface 150 is also included in FIG. 11 and may be implemented as a bus or other interface to facilitate communication among the components of the computing device 160.

The processor 145 may include any processing component configured to receive and execute computer readable code instructions (such as from the data storage component 148 and/or memory component 140). The input/output hardware 147 may include virtual reality headset, graphics display device, keyboard, mouse, printer, camera, microphone, speaker, touch-screen, and/or other device for receiving, sending, and/or presenting data. The network interface hardware 147 may include any wired or wireless networking hardware, such as a modem, LAN port, wireless fidelity (Wi-Fi) card, WiMax card, mobile communications hardware, and/or other hardware for communicating with other networks and/or devices. The network interface hardware 147 may communicate via the Internet to receive vehicle data provided from one or more sources as well as communicate with a display device, such as virtual reality headset 102 to display the virtual vehicle and virtual environment.

The components illustrated in FIG. 11 are merely exemplary and are not intended to limit the scope of this disclosure. More specifically, while the components in FIG. 11 are illustrated as residing within the computing device 160, this is a non-limiting example. In some embodiments, one or more of the components may reside external to the computing device 160.

It should now be understood that embodiments of the present disclosure are directed to systems and methods for creating and managing virtual vehicles in the form of non-fungible tokens that are tied to physical vehicles. An owner of a physical vehicle has ownership and possession of a corresponding virtual vehicle. A change in title of the physical vehicle causes a change in ownership of the virtual vehicle on a blockchain. Embodiments also provide for the rendering and operating of the virtual vehicle in a virtual environment that corresponds to the actual physical vehicle. The virtual vehicle operating in the virtual environment operates with similar characteristics of the physical vehicle in the physical world. In this way, a virtual vehicle is personalized and customized to match the owner's physical vehicle.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

1. A system for managing a virtual vehicle comprising:
one or more processors;
a non-transitory computer-readable medium storing instructions that cause the one or more processors to:
receive a vehicle identification number of a physical vehicle;
generate a non-fungible token for the physical vehicle on a blockchain, the non-fungible token providing a virtual vehicle corresponding to the physical vehicle, wherein the virtual vehicle is renderable in a virtual environment;
monitor one or more vehicle registration systems for a change in a title of the physical vehicle using the vehicle identification number; and
when a change in the title of the physical vehicle is determined:
determine a new owner of the physical vehicle; and
record a new owner name of the new owner of the physical vehicle on the blockchain to transfer ownership of the virtual vehicle to the new owner of the physical vehicle.

2. The system of claim 1, wherein transfer of the title of the physical vehicle results in transfer of ownership of the non-fungible token representing the virtual vehicle.

3. The system of claim 1, further comprising automatically notifying the new owner to complete transfer of the ownership of the non-fungible token.

4. The system of claim 1, wherein the virtual vehicle is a virtual rendering of the physical vehicle.

5. The system of claim 4, wherein the virtual vehicle has similar performance characteristics in the virtual environment as the physical vehicle in a physical environment.

6. The system of claim 1, wherein the vehicle identification number is received upon generation of the vehicle identification number by a vehicle manufacturer.

7. The system of claim 1, wherein the instructions further cause the one or more processors to:
receive a request to provide temporary access of the physical vehicle and the virtual vehicle from an owner to a third party for a duration of time; and
record the third party on the blockchain to transfer ownership of the virtual vehicle to the third party for the duration of time.

8. The system of claim 7, wherein the instructions further cause the one or more processors to:
push an authentication user interface to a display within the physical vehicle;
receive an authentication of the third party from the physical vehicle; and
upon authentication verification, record the third party on the blockchain to transfer ownership of the virtual vehicle to the third party for the duration of time.

9. The system of claim 7, wherein the instructions further cause the one or more processors to record the owner of the physical vehicle on the blockchain to transfer ownership of the virtual vehicle back to the owner of the physical vehicle.

10. A system for managing a virtual vehicle comprising:
one or more processors;
a non-transitory computer-readable medium storing instructions that cause the one or more processors to:
receive a vehicle identification number of a physical vehicle that is subject to a lease;
generate a non-fungible token for the physical vehicle on a blockchain, the non-fungible token providing a virtual vehicle corresponding to the physical vehicle, wherein the virtual vehicle is renderable in a virtual environment;
record ownership of the non-fungible token to a lessee of the physical vehicle at a start of the lease on the blockchain, wherein ownership of the non-fungible token grants access to the virtual vehicle; and
upon termination of the lease, automatically record ownership of the non-fungible token to a lessor on the blockchain, thereby terminating access to the virtual vehicle for the lessee.

11. The system of claim 10, wherein the virtual vehicle is a virtual rendering of the physical vehicle.

12. The system of claim 11, wherein the virtual vehicle has similar performance characteristics in the virtual environment as the physical vehicle in a physical environment.

13. The system of claim 10, wherein the instructions further cause the one or more processors to:
receive a request to provide temporary access of the physical vehicle and the virtual vehicle from an owner to a third party for a duration of time; and
record the third party on the blockchain to transfer ownership of the virtual vehicle to the third party for the duration of time.

14. The system of claim 13, wherein the instructions further cause the one or more processors to:
push an authentication user interface to a display within the physical vehicle;
receive an authentication of the third party from the physical vehicle; and
upon authentication verification, record the third party on the blockchain to transfer ownership of the virtual vehicle to the third party for the duration of time.

15. The system of claim 13, wherein the instructions further cause the one or more processors to record the owner of the physical vehicle on the blockchain to transfer ownership of the virtual vehicle back to the owner of the physical vehicle.

16. A system for managing a virtual vehicle comprising:
one or more processors;
a non-transitory computer-readable medium storing instructions that cause the one or more processors to:
generate a non-fungible token for a physical vehicle on a blockchain, the non-fungible token providing a virtual vehicle corresponding to the physical vehicle, wherein the virtual vehicle is renderable in a virtual environment;
receive a request to provide temporary access of the physical vehicle and the virtual vehicle from an owner to a third party for a duration of time; and
record the third party on the blockchain to transfer ownership of the virtual vehicle to the third party for the duration of time.

17. The system of claim 16, wherein the virtual vehicle is a virtual rendering of the physical vehicle.

18. The system of claim 16, wherein the virtual vehicle has similar performance characteristics in the virtual environment as the physical vehicle in a physical environment.

19. The system of claim 16, wherein the instructions further cause the one or more processors to:
push an authentication user interface to a display within the physical vehicle;
receive an authentication of the third party from the physical vehicle; and
upon authentication verification, record the third party on the blockchain to transfer ownership of the virtual vehicle to the third party for the duration of time.

20. The system of claim 16, wherein the instructions further cause the one or more processors to record the owner of the physical vehicle on the blockchain to transfer ownership of the virtual vehicle back to the owner of the physical vehicle.
